(19) United States
(12) Patent Application Publication
(10) Pub. No.: US 2016/0256847 A9
(43) Pub. Date: Sep. 8, 2016

(54) CENTRIFUGAL FLUID RING REACTOR

(71) Applicants: Richard Max Mandle, Palo Alto, CA (US); James Edward Grady, Mountain View, CA (US)

(72) Inventors: Richard Max Mandle, Palo Alto, CA (US); James Edward Grady, Mountain View, CA (US)

(21) Appl. No.: 14/110,736

(22) PCT Filed: Apr. 12, 2012
(86) PCT No.: PCT/US12/33238

§ 371 Date: Oct. 9, 2013

Related U.S. Application Data
(60) Provisional application No. 61/474,547, filed on Apr. 12, 2011.

(51) Int. Cl. B01J 19/18; C10L 1/02

(52) U.S. Cl. CPC B01J 19/1806; C10L 1/02

(57) ABSTRACT

The Centrifugal Fluid Ring Reactor employs a centrifugal impeller and a fluid barrier to mix multi-phase fluids and repeatedly move the mixture through a reaction zone, where the mixture contacts catalysts and/or is subjected to electromagnetic, mechanical, nuclear, or sonic energy to create ions, free radicals or activated molecules, which initiate or promote a desired reaction. It can be used to convert carbon dioxide, methane and other gaseous carbon sources into liquid fuel at ambient temperature and pressure.

### CROSS-REFERENCES TO RELATED APPLICATIONS

This application is a Continuation-in-Part of U.S. Ser. No. 61/474,547, filed Apr. 12, 2011. The contents of this preceding application are hereby incorporated in their entirety by reference into this application.

Throughout this application, various references are referred to and disclosures of these publications in their entireties are hereby incorporated by reference into this application to more fully describe the state of the art to which this invention pertains.

### FIELD OF THE INVENTION

This invention is a centrifugal reactor, which provides means to mix reactive fluids and simultaneously contact them with catalysts and/or expose them to a variety of types of energy to promote a desired reaction. The fluids may be immiscible and have different densities and may include both liquids and gasses. The reactor is suitable for converting carbon dioxide and methane into useful fuel products and for performing other multi-phase chemical reactions.

### BACKGROUND OF THE INVENTION

There are strong economic and environmental incentives for converting carbon dioxide, methane and other low molecular weight sources of carbon into more useful chemicals and fuels. The Fischer-Tropsch process has been used for nearly a century to produce hydrocarbon fuel (gasoline, diesel, etc.) from gasified coal or natural gas at high temperatures and pressures assisted by catalysts. In that process, methane and steam can be reformed to Syngas (CO and H₂), which then can be further converted to fuel. In another process, methane and carbon dioxide can also be reformed to form CO and H₂ for further processing into fuel. These processes require high temperatures and pressures and have high catalyst, energy and capital costs.

In the last few decades, methods have been developed for reforming low molecular weight carbon compounds, such as methane, propane, methanol and ethanol into higher molecular weight carbon compounds without using high temperature and pressure. These processes are described in numerous patents and scientific publications. Among the most promising processes being developed are those that employ non-thermal plasma to create free radicals, ions and/or activated molecules, which react to form larger, more useful molecules. These are discussed in the references in the “Reference” sectionlater.

Centrifugal force is commonly used to mix, move and/or separate fluids in reactors for chemical processes. Intense mixing of liquids and gases can be achieved in a centrifugal reactor, and energy to promote the desired reaction can be generated by mechanical force, which causes shear forces, cavitation or sonic energy.

A recent example is US 2006/0140828, “Centrifugal Reactor with Residence Time Control” (Winnington et al.), wherein multiple rotating elements provide along reaction path for fluids fed through it. Another recent example is US 2009/0293346 “Integrated Reactor and Centrifugal Separator and Uses Thereof”, (Birdwell et al.) which describes how to produce biodiesel from triglycerides and alcohols in a centrifugal reactor/separator. However, neither of these uses solid catalysts or the reverse flow mixing feature of the fluid ring reactor.

Spinning basket catalyst reactors (sometimes called Carberry Spinning Basket Catalyst Reactors) are available from commercial sources for use in laboratory studies. In them, baskets containing solid catalyst are attached to a vertical shaft in a cylindrical reactor. Propeller stirrers are attached above and below the baskets, so as to force fluids to flow towards the baskets when the shaft is rotated. At the same time, the rotation of the baskets also forces fluid through the catalyst baskets. There is a wide clearance between the baskets and propellers and the walls of the reactor vessel, which allows fluids to circulate outside the baskets and propellers. Energy is supplied through the fluids. These devices do not incorporate the reversing flow and concurrent exposure to a variety of kinds of activating energy that are features of the fluid ring reactor.

There are many examples of different ways of supplying energy to promote reactions in centrifugal reactors. The energy may be thermal, sonic, electric, radiant, mechanical or nuclear, and can be externally provided or internally generated. For one example, in US 2008/0256845, “Microwave-enhanced Biodiesel Method and Apparatus” (Meikrantz), the synergistic effect of microwave energy and centrifugal separation enhances the reaction of feedstock with light gasses.

In US 2010/0329944, “System and Process for Production of Liquid Product from Light Gas” (Hassan et al) a rotor is designed to generate high shear forces to disperse light gas in a liquid feed. This high shear may cause cavitation in a similar manner as in US 2008/0236160, “Continuous Flow Sonic Reactor and Method” (Glotov), where a centrifugal pump is designed to generate sound at a sufficient intensity to cause cavitation and promote reactions in fluids. Holloway et al, in US 2009/0188157, “Device and Method for Combining Oils with other fluids and mixtures Generated Therefrom” also uses the extreme heat and pressure of cavitation to promote reaction between alcohols and fatty acids. Hassan, Glotov and Holloway are examples of centrifugal mixers for fluids where mechanical energy is converted to shear force or sonic energy to promote the desired reactions, but none of them employ solid catalysts or the reverse flow mixing feature of the fluid ring reactor.

There are numerous ways to employ electrical energy to form ions and free radicals to initiate reactions. Electrical energy may be generated in the reactor by various means. An example is found in U.S. Pat. No. 7,806,947, “Liquid Hydrocarbon Fuel from Methane Assisted by Spontaneously Generated Voltage”, Gunnerman, et al., wherein methane is bubbled up through a grid of catalytic metal wires immersed in a liquid petroleum fraction. The wires are insulated from a grounded frame. As the mixture of gas and liquid bubbles up through the catalyst grid, an electrical potential is generated between the catalyst wires and the frame. This electrical activity creates free radicals, which produce new molecules from the methane and liquid petroleum fraction and convert the methane to a liquid fuel. This method is in commercial use.

The electrical energy may be provided from outside the reactor to form a high-voltage-induced plasma in the reactor. Low temperature plasmas induced by high voltage fields through a dielectric material are able to create ions, free radicals and activated molecules at ambient conditions with relatively low power requirements. In the reference titled “Carbon Dioxide Reforming with Methane in Low Temperature Plasmas”, the authors discuss use of corona discharge and dielectric barrier discharge (DBD) plasmas to dissociate CH₄ and CO₂ and to reform the gasses to CO and H₂. A DBD cell or reactor is one in which two electrodes are separated by a dielectric, and the material to be treated passes through a space between the dielectric and one of the electrodes. The paper also compares plasma methods with the traditional thermal processes that require temperatures around 800° C. The plasma induced reaction proceeds as follows:

CH₄+CO₂→2CO+2H₂ (Syngas)

Numerous patents have been issued for devices and processes that use plasmas and arcs to initiate reactions to convert low molecular weight hydrocarbons and oxygenates into more useful higher molecular weight materials. A good overview of the state of the art is provided in US 2011/0190565, “Plasma Reactor for Gas to Liquid Fuel conversion”, Novoselov et al. (the '565 patent), where the reactants are subjected to a pulsed high voltage discharge to convert low molecular weight hydrocarbons into a liquid fuel. The inventor calls the reactor a “non-thermal, repetitively-pulsed gliding discharge reactor”. In '565, U.S. Pat. No. 7,033,551, “Apparatus and Method for Direct Conversion of Gaseous Hydrocarbons to Liquids”, Kong et al. is cited as an example of using a DBD reactor, coupled to an electrochemical cell, to achieve a similar result. U.S. Pat. No. 6,375,832, “Fuel Synthesis”, Eliasson et al. is cited in the '565 patent as an example of using a DBD reactor, packed with a solid catalyst, to convert methane and carbon dioxide into liquid fuel. The '565 patent also states that limiting factors of DBD systems are:” the non-chain character of the conversion processes . . . and the high activation energy (>400 KJ/mol.) of the primary radical formation process.” Also, low current and power density reduce the capability of the DBD systems. The “gliding arc process activates the molecules to “vibrationally- and rotationally-excited levels, which requires less energy than forming radicals as in a DBD reactor, and is a chain reaction. The net result is a much lower energy requirement when a gliding arc, or direct non-thermal arc, is employed.

None of the prior art discussed in this Background section has disclosed a centrifugal reactor for fluid reactants wherein a liquid ring is used to repeatedly contact the mixed reactants with catalysts and/or subject them to energy of a variety of types in the rotor.

### SUMMARY OF THE INVENTION

This invention is a centrifugal reactor, which provides means to mix reactive fluids (reactants) and simultaneously contact them with catalysts and/or expose them to a variety of types of energy to promote a desired reaction. The fluid reactants may be immiscible and have different densities and may include both liquids and gasses. The reactor has a rotating element, or rotor (impellor), encased in a larger circular or elliptical casing. The rotor is situated in close proximity to a wall of the casing. The rotor draws in and mixes the reactant fluids and ejects the mixture at its periphery. The rotor also imparts centrifugal force to a dense liquid to make it circulate around the inside walls of the casing as a fluid ring. The rotor is partially immersed in this fluid ring. The dense liquid in the fluid ring may be inert or a reactant. This fluid ring forces reactants back into each part of the rotor as it rotates into the fluid ring. The fluid ring may also transfer energy, separate products or otherwise assist the reaction. Means are provided to add energy to the mixed reactants or to contact them with a catalyst in the rotor to promote the desired reaction. Catalyst may be part of the rotor, or may be contained in chambers on the rotor, so that fluid mixture passes back and forth over the catalyst as the rotor revolves through the fluid ring. Energy can be generated in the apparatus or supplied. Chemical, electrical, mechanical, nuclear, radiant and/or sonic energy may be employed. Electrical energy may be used to generate plasma in the reactor. The centrifugal force can be used to quickly remove a gaseous or dense liquid product from the reaction zone to drive the reaction in a desired direction and increase yield of desired products.

### DETAILED DESCRIPTION OF THE FIGURES

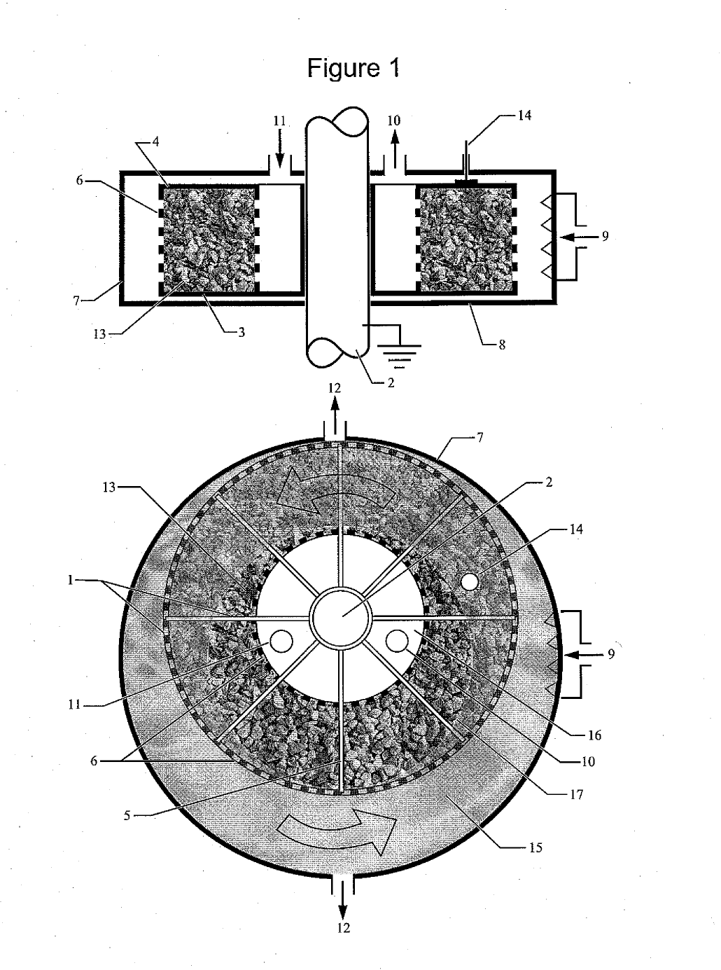

FIG. 1 is a drawing of the Centrifugal Fluid Ring Reactor as described in embodiment 1 of the invention.

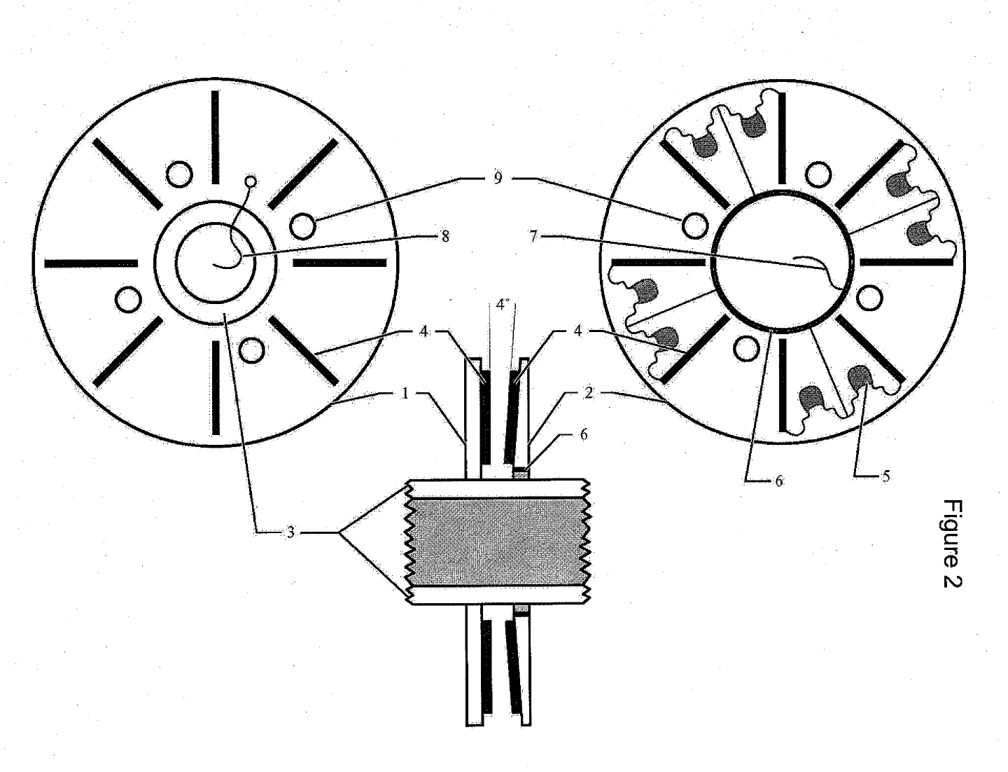

FIG. 2 is a functional representation of the rotor used in a demonstration of embodiment 3.

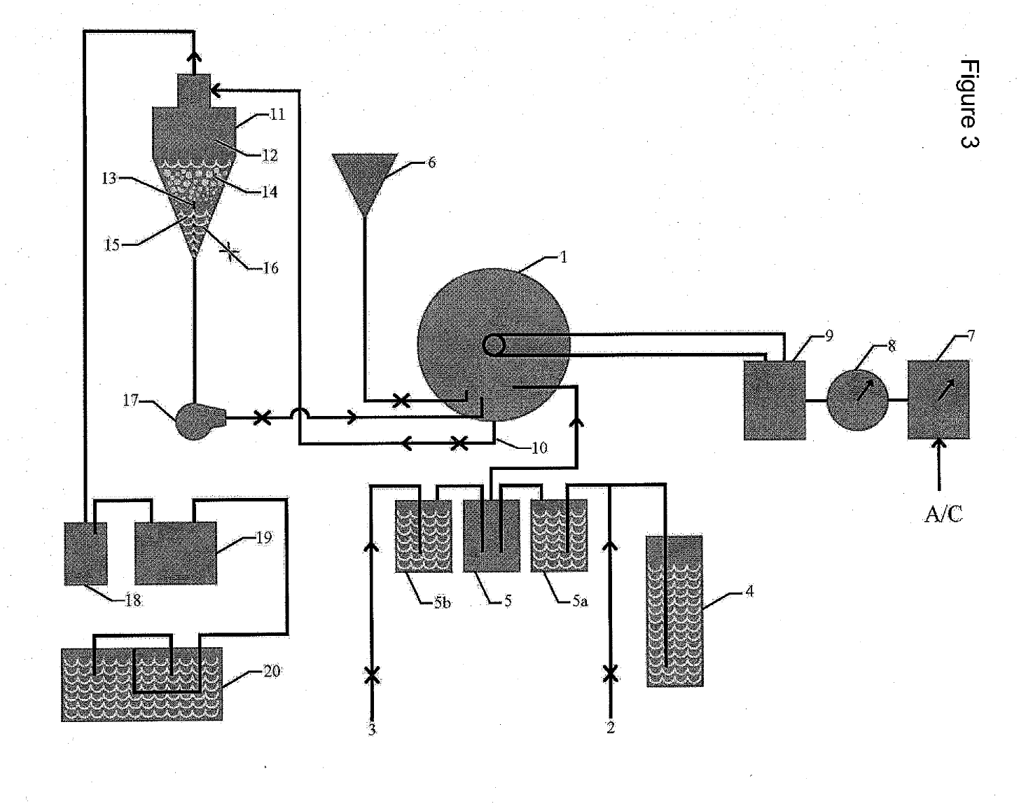

FIG. 3 is a schematic drawing of the process used in the demonstration of embodiment 3.

### DETAILED DESCRIPTION OF THE INVENTION

### The Apparatus

The apparatus is a centrifugal reactor, which provides means to mix reactive fluids (reactants) and simultaneously contact them with catalysts and/or expose them to a variety of types of energy to promote a desired reaction. The fluid reactants may be immiscible and have different densities and may include both liquids and gasses. The reactor has a rotating element, or rotor (impellor), encased in a larger circular or elliptical casing. The rotor draws in and mixes the reactant fluids and ejects the mixture at its periphery. The rotor also imparts centrifugal force to a dense liquid to make it circulate around the inside walls of the casing as a fluid ring. The rotor is situated in close proximity to the walls of the casing at one or more places, where it is partially immersed in the fluid ring. The dense liquid in the fluid ring may be inert or a reactant. This fluid ring forces reactants back into each part of the rotor as it rotates into the fluid ring. The fluid ring may also transfer energy, separate products or otherwise assist the reaction. Means are provided to add energy to the mixed reactants or to contact them with a catalyst in the rotor to promote the desired reaction. Catalyst may be part of the rotor, or may be contained in chambers on the rotor, so that fluid mixture passes back and forth over the catalyst as the rotor revolves through the fluid ring. Energy can be generated in the apparatus or supplied. Chemical, electrical, mechanical, nuclear, radiant and/or sonic energy may be employed. Electrical energy may be used to generate plasma in the reactor

The rotor element is a generally cylindrical shape. It is mounted on a shaft that allows it to spin on its axis. The rotor is rotated by an external force acting on its shaft, as from an electric motor, or by a force acting directly on the rotor, such as magnetic drive.

The rotor has several functions: it acts as an impellor to impart centrifugal force to the reactant fluids, which in turn mixes the fluids and forms the dense fluid ring; it provides a reaction zone where various forms of energy initiate and promote the desired reaction; and it carries mixed fluids into the dense fluid ring so they are pushed back though the reaction zone. The rotor may consist of one or more disks, which act as the impellors of a centrifugal pump. The disks may have radial blades on them that increase impellor efficiency. Alternatively, the rotor may be comprised of blades that attach to and radiate from the axis and act like paddles to impart centrifugal force to the fluids. The rotor may also be in the form of one or more fibrous brushes. The number of blades or chambers will depend on the size of the rotor and process variables, such as fluid viscosity, fluid density, etc., but normally will be at least eight.

The volume enclosed by the rotor is generally where the desired reactions take place, or the reaction zone. Various means are employed there to promote the desired reaction by generating ions, free radicals and activated molecules in the mixed fluids. To accomplish this, the fibers, disks and/or blades may be partly or entirely fabricated of catalytic, piezoelectric or radioactive material, and/or may have chambers or other means to hold such materials. Electric energy can be used to generate plasmas in the reaction zone. External heat and radiation can be applied through the casing walls or sides.

The casing has walls and sides that enclose the rotor and provide room for the circulating fluid ring and the fluids outside the rotor. The sides of the casing are joined around their edges by walls that enclose a space with a volume substantially larger than that of the rotor. The casing sides are generally flat and parallel to the sides of the rotor, but the walls and sides around the reaction zone must be close to the rotor to restrict circulation of fluids between them and the rotor, so they must be configured to conform to a rounded rotor if one is used. The space enclosed by the casing is preferentially circular or elliptical, but may be altered from these shapes to improve performance of the reactor, as for example: to form an arc long enough to completely close one of the chambers on the rotor; to form a bulge ahead of the rotor to accommodate water removal; etc. Likewise, the volume of the casing and the diameter of the rotor can be selected to meet process requirements, such as: viscosities of materials; vapor/liquid ratio; etc. Appropriately located ports provide means of feeding, removing and recycling fluids, e.g., feed and recycle liquids are injected near the shaft and feed and recycle gasses are injected through the liquid ring.

Although it is particularly suited for use with solid catalysts, the apparatus can also be used as a high-intensity mixer for reactive fluids when a soluble or liquid catalyst is used, or when no catalyst is required.

### A First Embodiment

In one embodiment, the apparatus is configured to process gaseous and liquid reactants in contact with solid catalysts. The rotor is comprised of a full disk with radial blades that are partially covered by a partial disk extending from the periphery towards the shaft so as to form radial chambers. The open part near the shaft is the inlet for fluids to be drawn into the impellor. For this configuration, at least eight blades and chambers are usually used. The closed and open disks of the rotor are parallel to each other and perpendicular to the rotor axis. The casing is as described earlier.

The solid catalyst is placed in the rotor chambers in a form that permits intimate contact between the fluids and the catalyst, while permitting fluids to flow through the chambers. The catalyst is retained in the chambers by suitable means, such as mesh coverings over the inner and outer openings of the chambers, or by being in wire form attached to the rotor. The inner surfaces of the chambers may be insulated so that electrical charges may be generated by the flow of bubbles through the catalyst as in U.S. Pat. No. 7,806,947, Gunnerman, et al., referred to above.

Features of the reactor described above are shown in

FIG. 1, as further described below.

The rotor (1) is affixed to shaft (2) by the full, or drive, disk (3). Impellor blades (5) extend between the drive disk and a partial disk (4). The open ends of the chambers formed by the disks and blades are closed by mesh (6) to contain solids (13) in the chambers. Solids may be catalysts, piezoelectric materials, nuclear emission materials or combinations of these or other materials to initiate and promote the desired reaction.

The chamber is enclosed by walls (7) and sides (8) to contain the fluids. Ports are provided for feeding and removing fluids. The location and number of ports can be changed to meet requirements of various reactions, but generally, gasses are fed through the casing wall (9) and removed through the casing side near the center (10). Liquids are fed near the center of the rotor (11) and removed through or near the casing wall (12).

Energy to promote the desired reaction can be generated within the apparatus and/or supplied from an external source. The fluid streams can be heated or cooled outside the reactor or heat can be added through the chamber walls and sides. The intense mixing of multiple phase fluids, the pulsing flow across the catalyst and high mechanical shear caused by the rotation of the rotor can produce sonic, electrostatic and/or mechanical shear energy to produce ions or radicals required for reactions to take place. Piezoelectric materials can be added in or near the catalyst to produce high voltage electricity from the mechanical agitation in that area. Likewise, electrical, magnetic or radiant energy may be supplied to the reactor by various means. One such means is to have the partial disk composed of a dielectric material and have electrical contacts through it into each chamber that are in sliding contact with an external source of electricity (14).

The rotor is situated in close proximity to a wall of the casing. As it is rotated, it throws liquids out against the walls of the casing and causes these liquids to form a circulating ring (15) around inside the casing walls. As each chamber of the rotor approaches the point where the rotor is near the casing wall, the fluid in the ring enters the chamber and pushes other contents of the reactor back through the chamber. As the chamber rotates to the opposite side of the rotor, the fluid in the ring moves out of the chamber and the other contents move back in. This back-and-forth flow occurs each time the rotor revolves. The dimensions of the rotor and rotational speed are chosen to create this back-and-forth action for materials of various densities, viscosities, solubilities and other physical characteristics.

The catalysts may be any of those known to one skilled in the art to be effective for the reaction to be performed. When solid catalysts are used, they are in a form that achieves high contact with the fluids, but permits fluid flow. They may be in the form of porous pellets, spheres, rods, wires, coarse powder or other high contact area form. When liquid or soluble catalysts are used, they are fed and mixed with other liquid feed or recycle.

### A Second Embodiment

In another embodiment, the rotor can be a circular brush consisting of fibrous catalyst, such as metal wire. As it spins, it acts as an impellor to throw mixed fluids outward to form a circulating fluid ring around the casing wall. At each revolution, the wires pass rapidly through the fluid ring, providing intimate contact between the catalyst and the ring fluids. Although there are no chambers on the rotor, centrifugal force repeatedly pushes the reactants out of the rotor and the fluid ring repeatedly pushes them back. The fluid ring also separates and isolates heavy products, such as water, from the reaction.

### A Third Embodiment

In this embodiment, the apparatus is configured to employ a non-thermal plasma in the rotor reaction zone. The rotor consists of two disks. Impellor blades are equally spaced radially around the opposing sides of the disks so that each blade is directly opposite a blade on the opposing disk surface. The distance between the opposing blades is adjustable, and increases from the shaft end to the outer edge of the disk. The blades on each disk are electrically connected to each other and these arrays of electrodes from each disk are separately connected by suitable means to a high voltage power supply so that they serve as opposing sets of electrodes for generating a non-thermal plasma in the space between the disks. The separation of the two sets of electrodes is typically about 0.016 to 0.25 inches near the shaft and increases from there outward by an angle of about 4°. The voltage is adjusted to be less than that required to create a hot arc between the sets of electrodes, and is typically about 10,000 volts. The disks and/or blades may be catalytic or a source of piezoelectric or nuclear energy.

A prototype device was built to demonstrate the operation of the apparatus employing opposing sets of electrode/impellors, as in embodiment 3. Details of the rotor are shown in FIG. 2 and described below.

The two disks have diameters of about 4 inches. One disc (1) has an electrically conductive copper surface and the other disk (2) has an electrically insulating surface. Disk 1 is mounted on a hollow acrylic shaft (3). Tungsten rods, ⅛ diameter by 1 ⅛ inches, containing 2% thorium are attached as impeller blades (4) on both disks. The tungsten is a catalyst and a good electrode material. The thorium enhances electron emission from tungsten and contributes some ionizing radiation. Disk 2 is attached to disk 1 by four screws (9), which are encased in insulating sleeves that serve as spacers between the disks. The electrodes are spaced 0.016 inch apart near the shaft. Their separation increases at an angle of 4° towards the periphery. A gap remains between the shaft and the edge of disk 2 to permit fluid circulation.

The copper surface of disk 1, and hence the electrodes attached to it, is connected by a wire (8) through the hollow shaft to a copper slip ring around the extended shaft. The electrodes on Disk (2) are connected through individual capacitors (5) and wires to a copper collar (6) at the inner edge of disk 2, and from there by wire (7) to another copper slip ring on the shaft. The capacitors (0.001 μf) balance the electric field among the individual electrodes.

The reactor and associated equipment is shown schematically in FIG. 3 and described below.

The reactor (1) is the one described immediately above. It receives gaseous feedstocks of CO₂ (2) and propane (3). The CO₂ supply is connected to a dip tube in a water-filled container (4) that maintains a 10 inch positive pressure on the system to prevent air from entering. The CO₂then goes through a “bubbler” (5a), which gives a visual measure of its flow rate. In similar manner, propane passes through a bubbler (5b) and the two gas streams are mixed in another chamber (5) before flowing to the reactor.

The reactor has an elliptical casing mounted with the major axis vertical, with the rotor situated at the lower end of the ellipse. One end of the rotor shaft is driven by a variable speed electric motor. The rotational speed was kept around 200 rpm for this trial. The other end of the shaft extends out of the opposite side of the casing, where two slip rings provide contacts for an external source of high voltage. The apparatus was operated at ambient temperature and no cooling or heating was provided to the reactor or process streams. The casing has a transparent side so that the contents of the reactor can be observed.

A liquid reactant ring fluid, kerosene, was added to the reactor through an elevated funnel (6). The rotational speed of the rotor was maintained at about 200 RPM, which was sufficient to maintain the liquid ring.

When the unit was purged and started, some CO was generated. The CO detector detected about 40-45 ppm of CO in gasses withdrawn from the separator funnel, indicating that the catalyst and process conditions were reforming some CO₂ without plasma. When power was applied, CO production increased quickly to over 950 ppm, which was the upper limit of the detector used. At that time, the characteristics of the fluid mixture changed and it was necessary to increase the power to the motor that rotates the rotor to keep the rotational speed constant.

Power was supplied from a “Variac” source of variable voltage (7) connected to a 115 volt alternating current source. The Variac used was a Realistic AC Power Supply. Model 106. The power was fed through an ammeter (8) to a Beckett 51838U Electronic Igniter (9), which produces an output voltage of 3.6 to 9.1 KV from an input voltage of 15 to 50 volts from the Variac. The power was supplied to the slip rings on the shaft of the reactor, and from thence to the opposing sets of electrodes.

The reactor was operated with a fluid ring depth of ½ to 1 inch. As the process continued, a fluid mixture was drawn off from the reactor (10) and was propelled by centrifugal force to an elevated separator funnel (11). There the gasses (12), kerosene with entrained gas (14) and water (15) were separated. The water was withdrawn from the system (16), the kerosene was returned to the reactor by a pump (17) and the gasses were passed through a container to remove entrained liquids (18) and then to a CO detector (19). Then it was collected over water in a gas collector. The presence of CO in the collected gasses was proof that CO₂ was reformed.

It was found that the ammeter was not accurate as used with the other electric components, but it did indicate changes in the power provided. As voltage to the reactor was increased, a point was reached when current suddenly increased. This indicated that a hot spark occurred, so voltage was decreased and maintained at a level at which only a non-thermal plasma was produced.

### Description of the Process

The process employs the Apparatus to intimately mix fluids and to contact the mixture with catalyst and/or expose it to a variety of types of energy to promote a desired reaction in a reaction zone in the rotor. It is especially useful for intimately mixing gasses with immiscible liquids, such as aqueous and hydrocarbon liquids. Fluids can be injected through a suitable opening in the casing near the inlet of the rotor, so as to be thrown by centrifugal force outward through the reaction zone of the rotor. Fluids, especially gaseous fluids, may also be injected through the casing wall to pass through the dense ring of fluid circulating there. Fluids are removed through ports in the walls or sides of the casing. Some may be recycled to the reactor, and the rest is passed to another reactor or removed for separation of the constituent materials.

As the rotor spins, it mixes the feed and recycle fluids and throws the mixture outward through the catalyst and out of the rotor. However, where the rotor is immersed in the fluid ring and close to the casing wall, the mixture cannot exit, and ring fluid enters the chamber, reversing the flow in the chambers in this zone. As each chamber rotates through this zone, the backward pulse agitates the contents of the chamber, which makes the contact between ingredients more efficient. The fluid is usually a dense layer of mixed feed and product fluids, or primarily the densest fluid in the process, but it can also be a fluid that does not participate directly in the reaction. Such a fluid may be chosen for its density or to remove or react with intermediate products to help drive the reaction to completion. For example, a silicone oil with density intermediate between water and hydrocarbon reactants, and immiscible with both, can be used as a liquid ring to isolate water from the hydrocarbon.

Gaseous fluids are fed through nozzles in the outer wall of the casing, or alternatively, through the side of the casing. The nozzles are designed to produce bubbles of gas that are less than one micron in diameter to enhance mixing and reaction with the other fluids. Ultrasonic nebulizers may be employed to achieve the desired small gas bubbles.

The casing is designed to accommodate the necessary ring depth and, when desired, to provide adequate room for a central gas zone that exposes the interior rim (i.e., furthest from the casing wall) of the rotor. The casing shape must permit circulation of the ring fluid and provide optimal mixing conditions where the rotor contacts the side of the casing. This dictates use of a generally round or elliptical casing. However, it may deviate from purely circular or ellipsoid to increase or decrease conformance between the rotor and the casing wall or to enlarge or diminish the clearance upstream or downstream of the rotor contact point, as the viscosity, density or other fluid qualities may require.

The revolution speed of the rotor must be fast enough to sustain the circulating fluid ring, but slow enough to permit the desired reverse flow of fluids through the catalyst chambers, which can be observed through a transparent side of the casing or a window in the casing side. The proper revolution speed will vary with the viscosity and density of the fluids being processed.

The apparatus design can be adapted to meet a variety of process requirements, such as: ratio of reactants; viscosity of fluids, density of fluids; retention time in reactor, mixture characteristics, operating pressure, operating temperature, etc. For example, factors determining residence time include casing volume and the feed rate for reactants and recycle fluids, balanced by the withdrawal and recycle rates of the mixture of fluids.

Energy may be supplied to the reaction by several different means, either internally within the apparatus or externally through feed and recycle fluids. Likewise, energy from exothermic reactions may be removed in the apparatus, as with a cooling jacket, or externally by cooling the feed and recycle fluids.

The pulsing pressure in the catalyst chambers may be used to generate energy within the catalyst chambers by putting piezoelectric materials in the chambers. The agitation can also generate electrical potential, as in “Gunnerman”, through the relative motions of differing materials or magnetic materials.

Temperature in the fluids may be controlled by sensors to add or remove energy within the cavity or by external means. An electric potential can be applied to the catalyst from an external source to generate plasma in the reactor. When a reactor is configured as in embodiment 3, the gap between opposing electrodes may be adjusted to meet process requirements, such as: the dielectric strength of mixed fluids, the voltage and frequency of the power source, etc. Magnets in the casing can be employed to subject the contents of the chambers to a fluctuating magnetic field. The chamber may also contain an ionizing radiation source, or have radiation applied from an external source, such as infra-red, microwave, nuclear or ultraviolet.

The material withdrawn from the reactor, either as a mixture or as separate constituent parts, can be passed through additional reactors to increase yield of desirable products. Products are separated from unreacted original materials and purified by appropriate processes, such as extraction, distillation, settling, centrifugation, etc. The apparatus is used as one constituent of a system that requires pumps, settling tanks, centrifuges, heat exchangers, distillation columns, extraction columns, etc. as required for the process.

This apparatus can be used as a mixer or reactor in processes where no solid catalyst is used, i.e., when a liquid catalyst is used or when no catalyst is required. In that case, the catalyst is omitted and mixing can be enhanced by covering the periphery of the rotor with a mesh or perforated film to increase agitation as fluids exit and reenter the chambers. The fluid ring features of this invention are still of value when no solid catalyst is used, namely: vigorous mixing as materials are forced back and forth through the rotor; and rapid separation of reaction products.

### Uses

The apparatus and process may be used for a wide variety of multi-phase reactions. It is well suited for recovering carbon from low molecular weight carbon compounds by reacting them with higher molecular weight carbon compounds, such as reacting natural gas with diesel fuel. In this case a rotor described in the third embodiment above would be used.

The centrifugal fluid ring reactor may also be used in the production of biofuels, where small units located near ethanol plants could be used to convert the ethanol to motor fuel by reacting it with vegetable oils (triglycerides) to produce long chain fatty acid esters (biodiesel) and glycerin. In this process (see U.S. 2010/0008835 for a description of the process) immiscible ethanol and vegetable oil must be mixed with a catalyst and the denser glycerin must then be separated from the reactants.

### REFERENCES

“Carbon Dioxide Reforming with Methane in low Temperature Plasmas”: Supat, et al., Fuel Chemistry Division Preprints 2002, 47(1), 269
“Kinetic Modeling of Plasma Methane Conversion Using Gliding Arc”: Indarto, A., et al., Journal of Natural Gas Chemistry 14(2005) 13-21
“Dielectric barrier discharges used for the conversion of greenhouse gases: modeling the plasma chemistry by fluid simulations”: DeBie, et al., Plasma Sources Science and Technology 20 (2011) 024008 (11 pp)
“Dry Reforming of Methane Using Non-Thermal Plasma-Catalysis”: Gallon, H. J. Thesis submitted to the University of Manchester for the Degree of Doctor of Philosophy in the Faculty of Engineering ad Physical Sciences. 2010

What is claimed is:

1. An apparatus employing centrifugal force to mix and react two or more reactive fluid materials comprising:
a) a cylindrical rotor comprising one or more disks mounted on a shaft through its axis and enclosed in a casing with the periphery of said rotor being in close proximity to one or more walls of a casing; said rotor having means for rotating the rotor on its axis, so that it imparts centrifugal force to fluids to expel them at the periphery of the rotor, and having one or more means to initiate and promote reactions between the reactive fluids as they pass through the rotor;
b) a casing having sides parallel to and in close proximity to the ends of the rotor of claim 1 a), said sides of the casing being joined around their edges by walls that enclose an annular space to contain the rotor and fluids being mixed, having means for feeding fluids into the casing and removing fluids from the casing and having means for adding and removing energy from the apparatus; and
c) a dense layer of fluid around the inside wall of the casing of claim 1 b), in which the rotor is partially immersed, said dense layer being formed and maintained by being thrown out to the casing wall and caused to circulate around said wall by the centrifugal force imparted by the rotor; so that said dense layer forces less dense fluids back through the rotor as it is immersed in the dense layer of fluid by the rotation of the rotor.

2. The apparatus of claim 1, wherein the rotor comprises a disk with radial blades as the elements that impart centrifugal force to fluids to expel them at the periphery of the rotor, and a second partial disk that is attached to the blades and extends from the periphery towards the center of the rotor so as to form radial chambers, bounded by the full disk, walls of adjacent blades and the partial disk, with openings in each chamber near the shaft and at the periphery of the rotor.

3. The apparatus of claim 1, wherein the rotor comprises one or more disks, which comprise fibrous materials that form a brush.

4. The apparatus of claim 1, wherein the rotor comprises two disks, and the radial elements of the rotor that impart centrifugal force to fluids are separate sets of radial blades situated opposite each other on their opposing surfaces.

5. The apparatus of claim 1, wherein the means to initiate and promote reactions between the reactive fluids comprise one or more of catalytic, electrical, electromagnetic, electrostatic, mechanical, radioactive and sonic means.

6. The apparatus of claim 2, wherein means to initiate and promote reactions between the reactive fluids comprise one or more catalytic, piezoelectric and radioactive solid materials placed in the chambers and held in place by mesh covering the central and peripheral chamber openings.

7. The apparatus claim 6, wherein the catalytic, piezoelectric and radioactive solid materials are of one or more forms comprising rods, wires, pellets and coarse powders.

8. The apparatus of claim 6, wherein the catalytic means comprise transition metals.

9. The apparatus of claim 6, wherein the transition metals comprise one or more of cobalt, iron, nickel and tungsten.

10. The apparatus of claim 6, wherein the radioactive means comprise one or more of thorium and uranium.

11. The apparatus of claim 3, wherein the brush comprises one or more catalytic, piezoelectric and radioactive materials.

12. The apparatus of claim 4, wherein the sets of blades on each rotor are connected electrically to a different pole of an external high voltage supply source to create a high voltage field through the space between opposing rotor blades.

13. The apparatus of claim 12, wherein the rotor blade materials comprise one or more catalytic and radioactive materials.

14. The apparatus of claim 12, wherein the rotor blade materials comprise one or more of cobalt, iron, nickel and tungsten transition metals and thorium and uranium radioactive metals.

15. The apparatus of claim 12, wherein the rotor blade materials comprise tungsten and thorium.

16. The apparatus of claim 12, wherein the external high voltage power provided is variable between 0 and 10,000 volts at frequencies between 50 to 20,000 Hertz.

17. The apparatus of claim 12, wherein the external high voltage power provided is between 3,000 and 9,000 volts at a frequency of 11,000 to 12,000 Hertz.

18. An apparatus employing centrifugal force to mix and react two or more reactive fluid materials comprising:
a) a rotor comprising an axis having a multiplicity of blades radiating from the axis to the periphery of the rotor, and being enclosed in a casing so that the periphery of said rotor is in close proximity to a wall of said casing and the ends of said rotor are in close proximity to the sides of said casing, said rotor having means for rotating the rotor on its axis, so that it imparts centrifugal force to fluids to expel them at the periphery of the rotor, and having one or more means to initiate and promote reactions between the reactive fluids as they pass through the rotor;
b) a casing having sides parallel to each other and in close proximity to the ends of the rotor of claim 19 a), said sides of the casing being joined around their edges by walls that enclose an annular space to contain the rotor and fluids being mixed, having means for feeding fluids into the casing and removing fluids from the casing and having means for adding and removing energy from the casing; and
c) a dense layer of fluid around the inside wall of the casing of claim 19 b), in which the rotor is partially immersed, said dense layer being formed and maintained by being thrown out to the casing wall and caused to circulate around said wall by the centrifugal force imparted by the rotor; so that said dense layer forces less dense fluids back through the rotor as it is immersed in the dense layer of fluid by the rotation of the rotor.

19. The apparatus of claim 18, wherein means to initiate and promote reactions between the reactive fluids comprise one or more catalytic, piezoelectric and radioactive solid materials placed in the chambers of the rotor and held in place by mesh covering the central and peripheral chamber openings.

20. The apparatus of claim 19, wherein the catalytic, piezoelectric and radioactive solid materials are of one or more forms comprising rods, wires, pellets and coarse powders.

21. The apparatus of claim 20, wherein the catalytic means comprise transition metals.

22. The apparatus of claim 20, wherein the transition metals comprise one or more of cobalt, iron, nickel and tungsten.

23. The apparatus of claim 20, wherein the radioactive means comprise one or more of thorium and uranium.

24. A process to convert low molecular weight carbon compounds into useful fuel products comprising:
a) introducing said low molecular weight carbon compounds together with a hydrocarbon fuel and water into an apparatus of claim 1;
b) using centrifugal force and a fluid ring to mix the low molecular weight carbon compounds together with a hydrocarbon fuel and water, while
c) simultaneously applying means for forming ions, free radicals or activated molecules in the mixture to initiate and promote the desired reactions; and
d) employing centrifugal force and a fluid ring to remove products of the reaction.

25. The process of claim 24, wherein the low molecular weight carbon compounds comprise one or more of COₓ, CₙH₂ₙ₊₂ and CₙH₂ₙ₊₂O, where x=1 or 2, n=2 to 5 and the hydrocarbon fuel comprises molecules containing six or more carbon atoms.

26. The process of claim 24, wherein the apparatus of claim 12 is used.

27. The process of claim 26, wherein the rotor blade material comprises one or more of cobalt, iron, nickel and tungsten transition metals and thorium and uranium radioactive metals.

28. The process of claim 26, wherein the rotor blade material comprises tungsten and thorium.

29. The process of claim 26, wherein the external high voltage power provided is variable between 0 and 20,000 volts at frequencies between 5,000 to 20,000 Hertz.

30. The process of claim 26, wherein the external high voltage power provided is between 3,000 and 10,000 volts at a frequency of 11,000 to 12,000 Hertz.
